(19) United States
(12) Patent Application Publication
(10) Pub. No.: US 2002/0099590 A1
(43) Pub. Date: Jul. 25, 2002

(54) Fulfillment management and control process

(76) Inventors: Victor Robert Abate, Clifton Park, NY (US); Marcus Edward Harrington, Clifton Park, NY (US); Christopher Nicholas Izzo, Burnt Hills, NY (US); Carlos Joaquin Suarez, Clifton Park, NY (US); Erik Scott Hallas, Ballston Spa, NY (US); Clement Harris, Albany, NY (US)

Correspondence Address: Alan M. Kagen, NIXON & VANDERHYE P.C., 8th Floor, 1100 North Glebe Rd., Arlington, VA, 22201-4714, US

(21) Appl. No.: 09/731,391

(22) Filed: Dec. 5, 2000

(51) Int. Cl. G06F 17/60

(52) U.S. Cl. 705/10

(57) ABSTRACT

A business management method integrates a complex, long cycle business into a common, concise format and set of order fulfillment metrics that provide clear status as well as predictive indicators of issues across all functional areas to all levels of management throughout an organization. The uniformity of the approach across all business functions allows for a standard comparison of the fulfillment risks and status across the entire business. The business management method utilizes statistical analysis, variation based metrics, mean based metrics, line rate analysis indicators and key quality indicators to facilitate proactive actions at the senior management level before issues become systemic and/or impact a company's ability to timely deliver products to its customers.

### BACKGROUND OF THE INVENTION

This invention relates to a business management method and, more particularly, to a business management method for monitoring an order fulfillment process of a product, particularly one with multiple components and independent processes that come together for a final product.

Order fulfillment for many corporations is the important process by which the translation of market orders into delivered products and services occurs resulting in realized revenue and income. The risks associated with poor execution of this process are significant as they often result in negative customer impact, cost overruns and large “hidden factories” of rework which are implemented in an attempt to keep the process moving. Ultimately, poor execution results in less than optimal company financial performance. On the other hand, the competitive advantages for companies that perform well are also clear as they utilize their assets more efficiently and often can leverage excellent and stable order fulfillment into their total competitive landscape through increased market share via pricing or research and development focused on strategic improvement.

It is important in executing the order fulfillment process to increase predictability and reliability. This is most pertinent during dynamic business climates such as times of increasing volume when a business finds itself becoming capacity constrained as well as times of organizational and functional change such as acquisitions. The capability of maintaining the order fulfillment process during times of severe change provides a competitive advantage.

As long cycle manufacturing businesses strive to be more competitive in a global market, the ability to execute efficiently and utilize the capital assets of the business more efficiently are important to this goal. This becomes even more evident as businesses globalize and source more components and subsystems from global suppliers while significantly increasing their inventory turns. The execution buffers in the system are often reduced and/or removed as the organization improves its financial performance, which requires a more predictable and stable order fulfillment process.

When a large long cycle business experiences a significant increase in demand and resulting output, the ability to accomplish this and the speed by which an organization can identify its pinch points and issues and launch resources to improve the situation can be the difference between success and failure. Excess capacity can be freed up as business process variation is reduced. When businesses are under a ramp up mode, the ability to understand the major sources of variation and launch improvement programs is important to the optimization and implementation of new assets and resources.

Often large organizations have difficulties with legacy systems that have over the years become disconnected regarding schedules and/or program plans across organizations. The ability to quickly identify scheduling disconnects and correct them is important to being able to ramp up volume. Moreover, as companies acquire capacity and/or other companies through acquisitions, the faster the speed by which they can integrate and coordinate their fulfillment demands with the new company's execution platform the better.

With traditional business control systems, only the factory output signal is tracked and often it is too late when an issue is surfaced to mitigate it. The need to have an early warning system and a predictive control system is important to providing reliable output to customers.

Many processes have been used to facilitate the business order fulfillment process with most focusing heavily at the end of the process. Often times, factory output is the key measure as opposed to the vital inputs to the factory as well as the supporting infrastructure. Most approaches lack an integrated “health” look across the entire process.

Most often when trying to control the order fulfillment process, organizations use the various legacy systems that inherently contain data accuracy issues regarding the true status of an operation. The result is poor accountability associated with the measurement data or metrics as they differ from reality when consolidated and reported. Also, often times the issues that are surfaced are not real, but resulting from data accuracy in “the system,” and time is wasted as people research the real status. Lastly, the lack of a common language across functions makes for difficult controllership across the business. The lack of a common controlling metric that is uniform across the entire order fulfillment process introduces variation in the business' ability to understand its true execution status. For example, engineering has internal metrics on drawings, the shop measures operations and the commercial team measures entire projects. The need for a common “currency” to report the entire process on is important.

Lastly, the prior art methods often had each function report from their own view their execution status. Often there is a difference of interpretation between important integration and handoff points. There is thus a need for a double entry accounting equivalent system to control the order fulfillment process.

### BRIEF SUMMARY OF THE INVENTION

In an exemplary embodiment of the invention, a business management method for monitoring an order fulfillment process of a product includes the steps of (a) setting control points corresponding to process milestones for product units from product order to product delivery and points in between; (b) comparing a cumulative product unit demand versus an actual number of cumulative product unit completions to determine whether execution flow is ahead or behind at each of the control points; (c) determining a delivery variance for individual product units based on product unit delivery timing; and (d) identifying potential capacity shortages at each control point according to line rate analyses based on product units per week. The method may further include the step of (e) maintaining a quality metric for each of the control points.

A summary of all metrics for each of the control points is preferably displayed on a single page. In this context, data from steps (b)-(d) is compiled into data matrices for each of the control points, the data matrices are arranged in columns according to functional ownership of respective process functions, and the columns are arranged chronologically according to the order fulfillment process sequence. An aggregate performance for each of the process functions may then be determined and displayed at a position adjacent its respective column. Portions of the display may be color coded to provide an alerting function based on poor aggregate performance.

The method may further include providing trend data corresponding to information from steps (b)-(d). In this context, data relating to the order fulfillment process thirty days ago, today, and thirty days ahead are preferably provided.

Step (c) may be practiced by determining how many product units are currently late for each of the control points, and by determining an average variation, a standard deviation of variation, and a maximum variation for each of the control points. Late product units are preferably flagged. Step (d) may be practiced by comparing an average number of product units per week that are required to stay on schedule with an average number of completed product units per week in the last thirty days, and by determining a number of product units per week that will be required in the next thirty days. Step (d) may be further practiced by determining a line rate ratio of the number of product units per week that will be required in the next thirty days to the average number of completed product units per week in the last thirty days.

In another exemplary embodiment of the invention a business management method for monitoring an order fulfillment process of a product includes setting control points corresponding to process milestones for product units from product order to product delivery and points in between; and monitoring and maintaining the order fulfillment process at each of the control points according to (1) a cumulative product unit demand versus an actual number of cumulative product unit completions, (2) a delivery variance for individual product units based on product unit delivery timing, and (3) line rate analyses based on product units per week.

### BRIEF DESCRIPTION OF THE DRAWINGS

FIG. 1 is an exemplary timeline of a gas turbine business process;

FIG. 2 is an exemplary data matrix used with the business management method of the present invention; and

FIGS. 3A and 3B show an exemplary summary of all business milestone metrics for the gas turbine business process.

### DETAILED DESCRIPTION OF THE INVENTION

In the following detailed description, the business management method of the present invention will be described in the context of its application to a manufacturing process for a gas turbine. This application, however, is merely exemplary as the business management method of the invention has a wide range of applications. The application is thus not meant to be limited to the described exemplary application.

At the core of this business management process is an Integrated Master Schedule (IMS). The IMS (shown below) is a system of scheduled dates that covers the entire business process from receiving the sales order through delivery of the product to the customer. Dates are maintained for only a few major process milestones. These milestones (or control points) are significant functional interface points or process pinchpoints and are selected such that the flow of product through these milestones alone will characterize the overall flow of product through the business.

IMS for Unit X

| | | Lead Time | | | | |
|---|---|---|---|---|---|---|
| | Control | to Mfg Cpit | Scheduled | Planned/ | | |
| Function | Point | (Days) | Date | Actual Date | Cpit | V |
| Sales | Order | | | | □ | |
| | Release | 165 | 9/16 | 10/17 | □ | 31 |
| Project | Order | | | | | |
| | Definition | 155 | 9/26 | 10/11 | □ | 15 |
| Engineering | Drawing A | 60 | 12/30 | 12/6 | | −24 |
| | Drawing B | 60 | 12/30 | 12/7 | □ | −23 |
| | Drawing C | 50 | 1/9 | 1/7 | □ | −2 |
| Sourcing | Component A | 80 | 12/10 | 12/10 | □ | 0 |
| | Component B | 75 | 12/15 | 12/12 | □ | −3 |
| | Component C | 90 | 11/30 | 12/4 | □ | 4 |
| | Component D | 25 | 2/3 | 2/3 | □ | 0 |
| Production | Machining A | 35 | 1/24 | 1/21 | □ | −3 |
| | Machining B | 28 | 1/31 | 1/31 | □ | 0 |
| | Assambly | 12 | 2/16 | 2/16 | □ | 0 |
| | Mfg Cpt | 0 | 2/28 | 2/28 | □ | 0 |
| | | | Scheduled Date: | Planned/Actual | Complete | Variance |
| | | | Load Time | Date: | Indicator | to |
| | | | Based Locked in | Current Status | | Schedule |
| | | | | Updated Weekly | | |

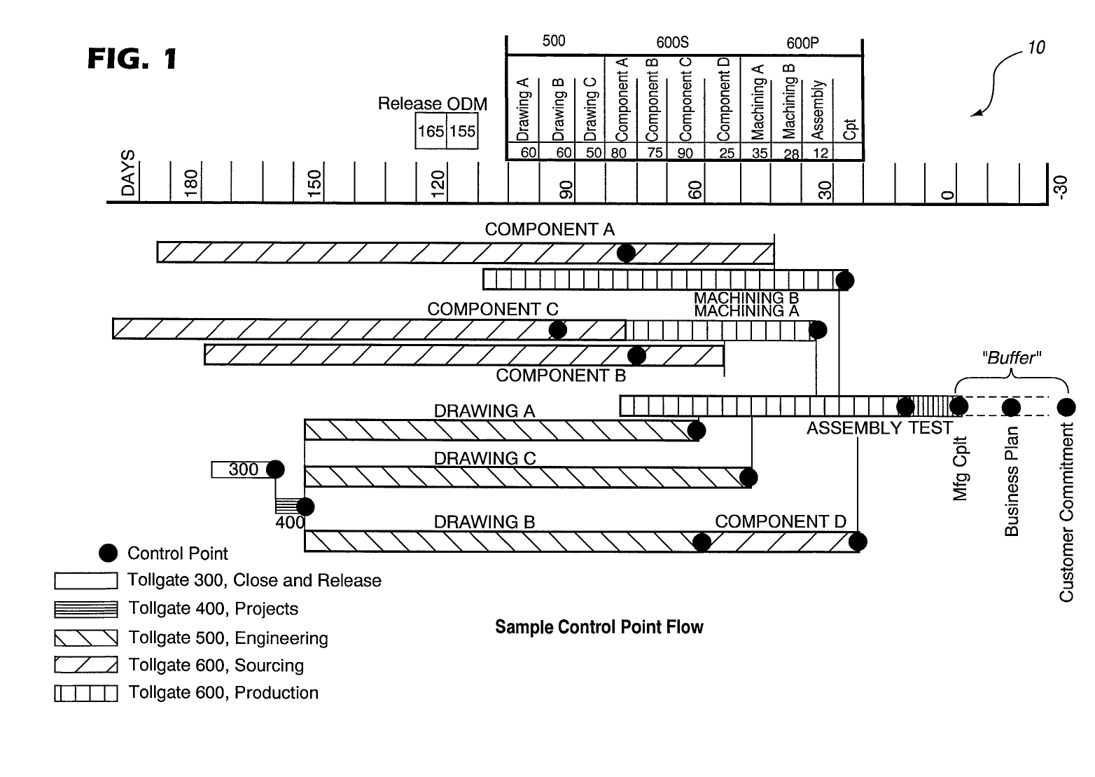

An IMS schedule is ideally established for every major customer deliverable. For each item, a manufacturing complete date is chosen, which is consistent with factory capacity loading and provides adequate “buffer” time to the customer commitments and business financial plans. The size of this buffer depends on the level of confidence the business has in its ability to execute the order to its planned schedule. Scheduled dates are then calculated for all business control points for that deliverable using standard lead times which are based on product type and model. The resulting network of schedule dates is then “locked-in” to drive execution stability across individual components of the process or functions. These schedules can be changed only as a result of changes in customer commitments or business volume/financial plans that must be approved by high-level leadership. The schedule dates are stored in a shared database that is accessible by representatives from all functions. An example timeline 10 of a gas turbine business process with the control points of interest identified is shown in FIG. 1.

An important element of this business management process is maintenance of accurate actual completion dates and projected (planned) completion dates for the next thirty days or more. These planned/actual dates are updated weekly by appropriate functional representatives in the shared database. A variance to schedule (V) is calculated for each item by comparing its IMS scheduled date to its corresponding planned/actual date. These V's are used to determine current and forecasted execution status for each milestone.

Since in large organizations this type of data is maintained in legacy systems that frequently become disconnected across organizations, all data is maintained and reported manually for input into the database. The control points being tracked are high-visibility and critical path. As a result, these dates can be readily routinely discussed, negotiated and drive leadership decisions at daily scheduling/production meetings. Their high visibility makes them readily available, consistently up to date and more reliable than any legacy system date. The fact that these dates are supplied manually by the functional owners also aids in driving personal accountability.

Whenever possible, the manual data is updated by the internal customer of the deliverable. For example, the completion date of a key engineering drawing may be updated by the production organization confirming that they are in agreement that the drawing is complete and available for their use. This “double entry accounting” element further increases the reliability of the planned/actual data.

The execution status variance to scheduled data described above is used to determine whether a particular function is ahead or behind, is adding variation, whether it can stay on track or catch up if behind, and an indication of the function quality. By the present invention, the respective information is summarized numerically in a data matrix.

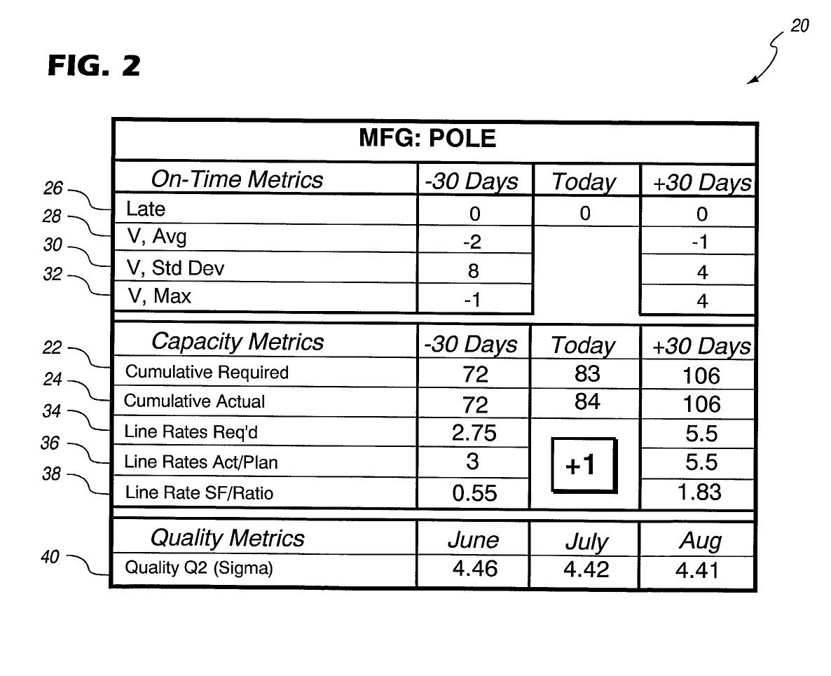

FIG. 2 is an exemplary data matrix 20 for discerning the respective information for each function at each of the control points. To determine whether the particular function is ahead of schedule or behind schedule, a “line of balance” (LOB) approach is used. For each control point, a cumulative demand profile 22 exists based upon the scheduled dates for unit completions. Similarly, a completion profile 24 exists based upon actual unit completions for the control point. If at a given point in time the cumulative demand exceeds the actual number of cumulative completions, execution flow is “behind” at that control point. Conversely, if actual cumulative completions exceed the cumulative demand, execution flow is “ahead” at that control point.

In the example data matrix of FIG. 2, the LOB position is indicated for this milestone at three points in time: thirty days ago, today, and a projected position thirty days into the future. The number of units ahead or behind as of today is shown in bold in the center of the matrix 20. In this example, the milestone is one unit ahead (+1).

Whether the function is ahead or behind is independent of the schedule sequence of deliverables. Due to poor prioritization or special causes on specific orders, a milestone can have individual late items and still be ahead overall by maintaining a sufficient overall throughput rate. If as a whole, however, the milestone falls “behind,” it is an indication of a situation in which the throughput capacity of the milestone as it is currently operating is insufficient. If necessary, action must be taken to reverse the trend to avoid continuously increasing numbers of late items. As a milestone falls further behind, it will eventually reach the point at which it can never catch up due to capacity limitations.

Milestones which are behind their LOB today or projected to be behind thirty days from now have their cumulative required and actual boxes flagged with a colored box (such as yellow) for the time period of concern.

Whereas the “Ahead or Behind” metrics are focused only on the cumulative throughput at any milestone, the variation metrics add the additional element of flagging correct sequencing. A unit that is late to the IMS at any milestone forces downstream processes to compress cycles to get back on track. This variation leads to the deterioration of system stability and commonly consumes excess resources due to expediting efforts and overtime. In the extreme case where the degree of lateness becomes too large, the overall process buffer may be eroded to the point where even these extra efforts may be insufficient to recover and deliver on time.

The first line 26 of the On-Time Metrics in the matrix of FIG. 2 identifies how many units are currently late to the IMS at each milestone. For comparison and trending purposes, this same value is also shown for thirty days in the past and forecasted for thirty days in the future. In the example of FIG. 2, there were no units late today or thirty days ago and there are no units anticipated to be late thirty days from now.

Late units today and projected late units thirty days from now are flagged with a colored box. In the case where a unit is so late that customer commitments or business financial plans are at risk, the box is shaded more darkly (such as in red).

The next three lines are statistics used to quantifiably describe the delivery variance (V) of each milestone in days early or late, where (−) is early, (+) is late. Three statistics are evaluated including average V 28, standard deviation of V 30 and the maximum V 32. Each of these statistics is evaluated over populations which cover two separate time periods: (1) all units completed in the last thirty days; and (2) all units planned or scheduled for completion in the next thirty days. In the example in FIG. 2, over the last thirty days, the units which were completed through this milestone were on average two days early with a standard deviation of eight days. The latest item completed was seven days late. In the next thirty days, the scheduled and planned units are expected to be completed on average one day early with a standard deviation of four days. The latest item is expected to be completed five days late. These metrics aid in evaluating whether the predominant cause of late units is a consistent inability to deliver on time (late average V) or excessive delivery variation (high standard deviation or max V) or both.

To aid in identifying potential capacity shortages at each milestone, line rate analyses are conducted and displayed. First, the average number of units per week that are required to stay on track 34 are compared to the average number per week that were completed 36 in the last thirty days. In the example above, 2.75 units per week were required to be completed to ensure that all units due by the date of the report were on time. An average of 3 units per week were actually completed resulting in being 1 unit ahead at the end of the thirty day period. Similarly, in the next thirty days, a minimum of 5.5 units per week are required to have no late units at the end of the period. The current plan is to complete exactly this amount.

The Line Rate Ratio (LRR) 38 helps evaluate a function's ability to deliver on its upcoming commitments at a control point. LRR is the ratio of required line rate in the next thirty days to the actual line rate in the last thirty days. If the LRR is high, meaning the upcoming requirements are significantly higher than the recently demonstrated performance, then a flag is raised. In the example in FIG. 2, the LRR is 1.83 (3/5.5) and its cell is shaded (blue) indicating that its value is higher than normal.

The flag does not necessarily indicate that a capacity disconnect exists, but does highlight the need for the function in question to address its execution plan for this substantial increase in demand. For businesses with a reasonably flat demand profile, a LRR of 1.5 or greater is a good indication of an issue for concern. In businesses which are experiencing more demand variability or a steadily increasing demand stream, a higher trigger level might be chosen to reduce the number of false alarms.

In the case where reliable throughput capacity information is available for an individual milestone, specific trigger points can be developed based on the required and planned line rates in the next thirty days. In the example of FIG. 2, the required and planned line rates are 5.5 units/wk. Based on the physical resource constraints of this operation, it is known that the actual maximum sustained line rate is 4 units/wk. The excessive line rates are flagged (for example, in yellow) to highlight the need for resolution.

Completing items on time alone provides no value if the quality of the deliverable is inadequate. Incomplete items or items requiring rework result in as much or more disruptions and instability downstream as late items do.

In order to keep the importance of quality on everyone's screen, a high level quality metric 40 is maintained for each milestone. The actual measurement can vary depending on data availability and deliverable type. The most common metric in manufacturing operations is based on a Defects/Unit or Defects/Opportunity calculation which takes into account the total number of defects generated by a process and normalizes them based on the total number of opportunities for defects that existed. In the example of FIG. 2, this defect/opportunity ratio is translated into a “sigma” value which is based on the normal curve. A higher sigma indicates better quality. For engineering drawings a more common measurement is “revision rate” which is the percent of time that a drawing must be revised and reissued due to errors or incompleteness.

In all of these analyses, an important element in achieving universal understanding is maintaining a standard unit of measure (or currency) for each milestone. Common practice in large organizations is that each function will discuss work volume in different units. Engineering will talk in terms of drawings; purchasing will talk in terms of purchase orders; manufacturing will talk in terms of assemblies. Though all of these units of measure may be invaluable in understanding and planning resource requirements within each function, they limit the business leader's ability to keep each function's performance in context with overall business execution. By ensuring that all functions measure their milestones in the same unit of measure, the ahead/behind, variation and capacity metrics can be used to make direct comparisons between functions and aide in decision-making relative to resources and focus.

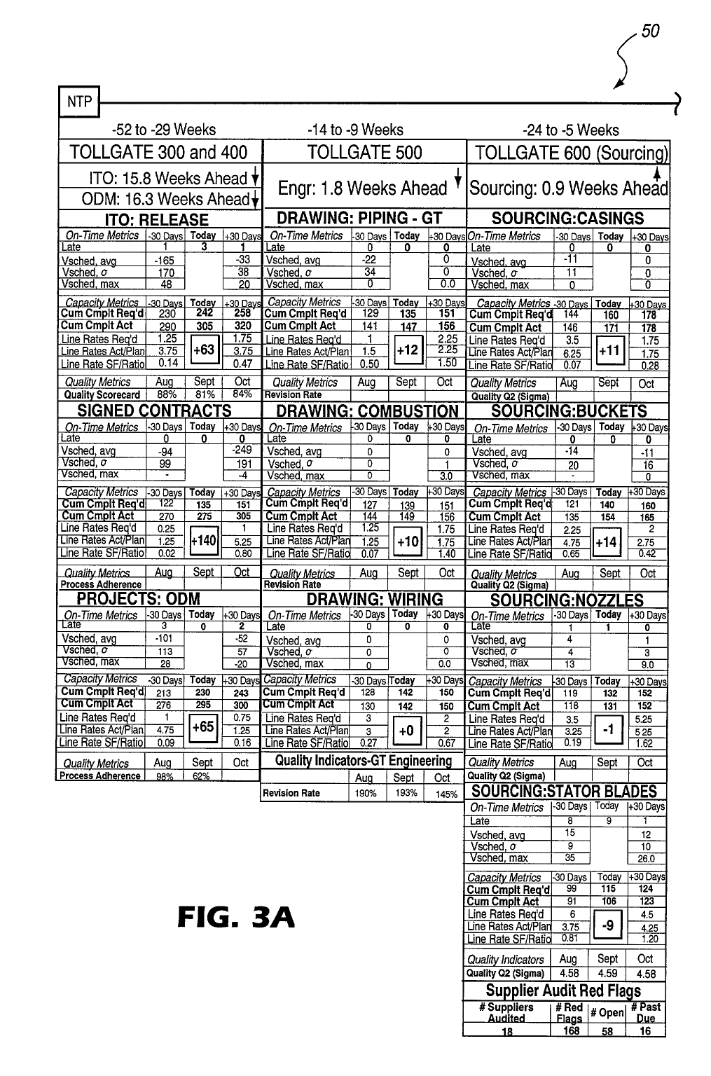

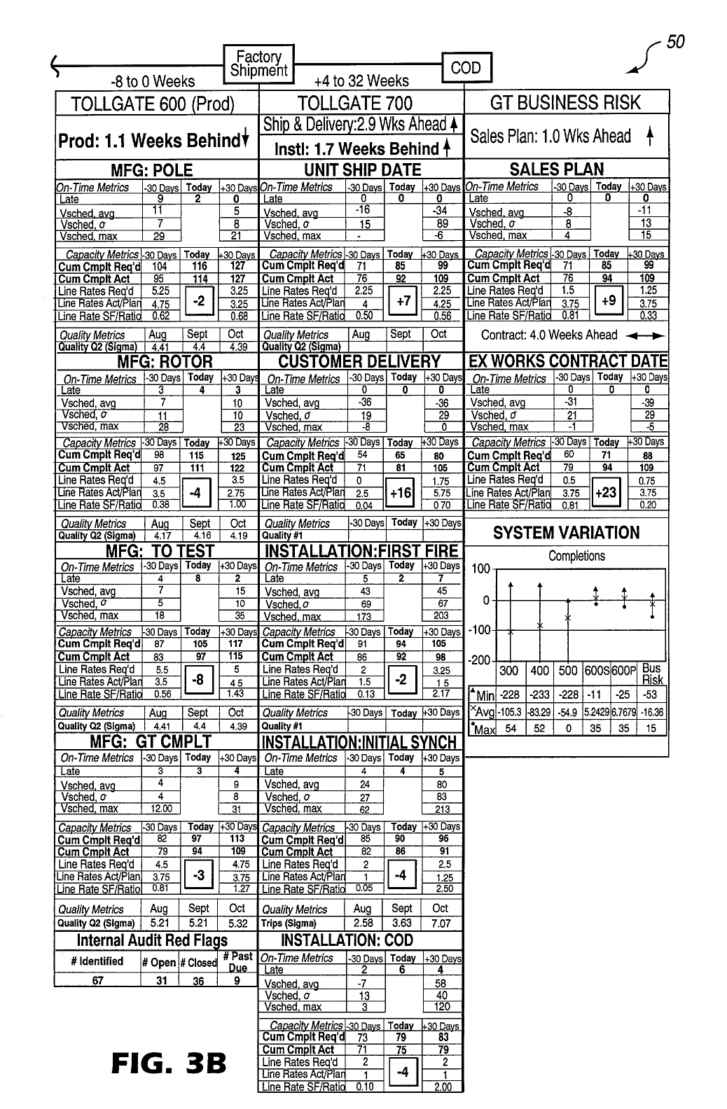

For review purposes, a summary of all business milestone metrics are assembled on a single page 50 to provide a snapshot of overall execution health for a particular product line. An exemplary single page 50 is shown in FIGS. 3A and 3B (for ease of illustration, the “single page” configuration is separated into FIGS. 3A and 3B—in a preferred application, the entire matrix of data matrices is arranged on a single page). The data matrices for all milestones appear on the sheet and are arranged in columns according to their functional ownership. The functional columns are then arranged left to right chronologically in accordance with the business process sequence.

At the top of each column, an aggregate performance for each function is calculated. This calculation is the average number of units ahead or behind for all the milestones in a function, divided by the required weekly business throughput in units per week. Using the production column as an example, the four milestones are on average 4.25 units behind ((-2-4-8-3)/4). At a required throughput of 4 units/week, the entire function is on average (4.25/4=) 1.1 weeks behind. Functions which on average are ahead of their LOB are indicated by a colored (green) header, and those that are behind are shaded differently (yellow). Arrows indicate week to week trends, up arrows for improvement, down arrows for decline.

On the far right is a column titled “Business Risk.” This shows the current status of the business buffers to customer contracts and financial commitments. In the example shown, one week of buffer remains for sales plan commitments and four weeks of buffer remain for contractual commitments. At one time, these buffers were approximately two weeks and five weeks, respectively. The fact that the production function has fallen more than one week behind has resulted in these buffers being reduced.

The one page summaries can be reviewed weekly by a high-level leadership team. A weekly discipline is required to ensure quick action to address execution issues across the entire business. The dedicated leadership involvement is important to driving functional accountability to the execution status, data and necessary recovery plans.

The focus of the review is on the highlighted (yellow or red) items which indicate execution issues. By focusing on the entire business process and not just on the end deliverable, concerns are identified as early as possible, thereby maximizing the available time to react and recover.

On a rotating basis, the leadership review will include a more detailed review of a specific function evaluating their milestones in more detail as well as reviewing other issues or concerns not specifically addressed by the one page summaries.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A business management method for monitoring an order fulfillment process of a product, the method comprising:
(a) setting control points corresponding to process milestones for product units from product order to product delivery and points in between;
(b) comparing a cumulative product unit demand versus an actual number of cumulative product unit completions to determine whether execution flow is ahead or behind at each of the control points;
(c) determining a delivery variance for individual product units based on product unit delivery timing; and
(d) identifying potential capacity shortages at each control point according to line rate analyses based on product units per week.

2. A business management method according to claim 1, further comprising (e) maintaining a quality metric for each of the control points.

3. A business management method according to claim 2, further comprising displaying a summary of all metrics for each of the control points on a single page.

4. A business management method according to claim 3, wherein the displaying step comprises compiling data from steps (b)-(d) into data matrices for each of the control points, arranging the data matrices in columns according to functional ownership of respective process functions, and arranging the columns chronologically according to the order fulfillment process sequence.

5. A business management method according to claim 4, further comprising determining an aggregate performance for each of the process functions.

6. A business management method according to claim 5, wherein the displaying step further comprises displaying the aggregate performance for each of the process functions at a position adjacent its respective column.

7. A business management method according to claim 6, wherein the displaying step further comprises color coding portions of the display to provide an alerting function based on poor aggregate performance.

8. A business management method according to claim 1, further comprising providing trend data corresponding to information from steps (b)-(d).

9. A business management method according to claim 8, wherein the step of providing trend data comprises providing data relating to the order fulfillment process thirty days ago, today, and thirty days ahead.

10. A business management method according to claim 1, further comprising providing an alerting function for information from steps (b)-(d) that indicates the respective product unit is falling behind schedule.

11. A business management method according to claim 1, wherein step (c) is practiced by determining how many product units are currently late for each of the control points, and determining an average variation, a standard deviation of variation, and a maximum variation for each of the control points.

12. A business management method according to claim 1 1, further comprising flagging late product units.

13. A business management method according to claim 1, wherein step (d) is practiced by comparing an average number of product units per week that are required to stay on schedule with an average number of completed product units per week in the last thirty days, and determining a number of product units per week that will be required in the next thirty days.

14. A business management method according to claim 13, wherein step (d) is further practiced by determining a line rate ratio of the number of product units per week that will be required in the next thirty days to the average number of completed product units per week in the last thirty days.

15. A business management method for monitoring an order fulfillment process of a product, the method comprising:
setting control points corresponding to process milestones for product units from product order to product delivery and points in between; and
monitoring and maintaining the order fulfillment process at each of the control points according to (1) a cumulative product unit demand versus an actual number of cumulative product unit completions, (2) a delivery variance for individual product units based on product unit delivery timing, and (3) line rate analyses based on product units per week.
